(19) United States
(12) Patent Application Publication
(10) Pub. No.: US 2026/0301519 A1
(43) Pub. Date: Oct. 1, 2026

(54) COMPUTING APPARATUS, SYSTEM AND METHOD FOR BALANCING PREDICTION SIGNALS FROM REMOTE TERMINALS

(71) Applicant: RAVEN SPADES INC., Toronto (CA)

(72) Inventor: Joshua TAN KENG WAH, Toronto (CA)

(21) Appl. No.: 19/476,874

(22) PCT Filed: Mar. 4, 2024
(86) PCT No.: PCT/IB2024/052078

§ 371 Date: Oct. 20, 2025

Related U.S. Application Data
(60) Provisional application No. 63/460,457, filed on Apr. 19, 2023.

(51) Int. Cl. G07F 17/32

(52) U.S. Cl. CPC G07F 17/3227; G07F 17/3272

(57) ABSTRACT

The present specification provides, amongst other things, a novel load balancing engine for use in interactive application that can adjust signals from electronic devices that connect to platforms in order to urge an overall system towards a utilization of a target amount of computing resources.

### CROSS-REFERENCE TO RELATED APPLICATION(S)

This application claims the benefit of U.S. Provisional Patent Application No. 63/460457, filed Apr. 19, 2023, entitled “COMPUTING APPARATUS, SYSTEM AND METHOD FOR BALANCING PREDICTION SIGNALS FROM REMOTE TERMINALS”, the entire contents of each of which are incorporated herein by reference.

### FIELD

The present disclosure generally relates to computing systems managing signals via communication networks, and more particularly the balancing of resource utilization.

### BACKGROUND

Computing apparatuses and communications systems are commonly employed to facilitate networked software interactions involving signals. Significant engineering resources can be expended designing and implementing a hardware platform that provides a given experience to those accessing the platform through remote terminals. However, remote terminals may exhibit varying signal flow reflective of user behaviour which may further influence utilization of the hardware platform. Thus computing resources of certain platforms are therefore under-utilized and/or imbalanced, resulting in wasted processor, memory and communication resources.

### SUMMARY

An aspect of the specification provides an interactive platform including a processor and a memory, the processor configured to: define a target resource utilization range of one or more of processor, memory and or bandwidth utilization of the platform; initiate an interactive application on the platform; determine a plurality of participating accounts associated with electronic devices that connect to the platform via a network; receive prediction signals for an outcome of the application from the at least a portion of the participating accounts; execute a phase of the application; determine which participating accounts generated prediction signals; allocate a first portion of a collective account to a value storage unit associated with one of the participating accounts associated with an accurate prediction; allocate a second portion of the collective account amongst one or more value storage unit associated with the other participating accounts based on a number of prediction signals received from the other participating accounts; wherein the second portion is adjusted to bring the overall number of prediction signals within the target resource utilization range utilization during subsequent phases.

An aspect the specification provides a system comprising a plurality of platforms hosting the interactive application according to the foregoing. The target utilization range includes one or more of processor, memory and bandwidth utilization of each platform. The target utilization range includes a substantial balancing of processor, memory and bandwidth utilization across each platform.

An aspect of the specification provides an interactive platform wherein the target range is between about 20% and about 80% of processor utilization.

An aspect of the specification provides an interactive platform wherein the target range is between about 30% and about 70% of processor utilization.

An aspect of the specification provides an interactive platform wherein the target range is between about 40% and about 60% of processor utilization.

An aspect of the specification provides an interactive platform wherein the target range is between about 45% and about 55% of processor utilization.

An aspect of the specification provides an interactive platform wherein the target range is about 50% of processor utilization.

An aspect of the specification provides an interactive platform wherein the target range is between about 25% and about 75% of memory usage.

An aspect of the specification provides an interactive platform wherein the target range is between about 35% and about 75% of memory usage.

An aspect of the specification provides an interactive platform wherein the target range is between about 40% and about 60% of memory usage.

An aspect of the specification provides an interactive platform wherein the target range is between about 45% and about 55% of memory usage.

An aspect of the specification provides an interactive platform wherein the target range is about 50% of memory usage.

An aspect of the specification provides between about 25% and about 75% of bandwidth usage of the network connection to the platform.

An aspect of the specification provides an interactive platform wherein the target range is between about 35% and about 75% of bandwidth usage of the network connection to the platform.

An aspect of the specification provides an interactive platform wherein the target range is between about 40% and about 60% of bandwidth usage of the network connection to the platform.

An aspect of the specification provides an interactive platform wherein the target range is between about 45% and about 55% of bandwidth usage of the network connection to the platform.

An aspect of the specification provides an interactive platform wherein the target range is between about 50% of bandwidth usage of the network connection to the platform.

An aspect of the specification provides a platform including a processor configured to: initiate an electronic game on the platform; determine a plurality of participating accounts associated with electronic devices that connect to the platform via a network; receive prediction signals for an outcome of the game from the participating accounts; execute a gaming phase of the electronic game; determine which participating accounts generated prediction signals; allocate a first portion of a collective currency account to a currency account associated with one of the participating accounts associated with an accurate prediction; allocate a second portion of the collective currency account amongst one or more of the other participating accounts based on a number of prediction signals received from the other participating accounts; wherein the second portion is adjusted to bring the overall number of prediction signals within a target range during subsequent initiation of the electronic game.

An aspect of the specification provides a gaming platform wherein the electronic game is poker and the gaming phase includes a plurality of hands of poker; the collective currency account represents a pot; the first portion represents the winnings; and the second portion represents a rakeback.

### BRIEF DESCRIPTION OF THE FIGURES

FIG. 1 is a schematic diagram of a system for balancing prediction signals.

FIG. 2 is a block diagram of example internal components of the load balancing engine of FIG. 1.

FIG. 3 shows a flowchart depicting a method for balancing prediction signals.

FIG. 4 shows the system of FIG. 1 performing certain blocks from the method in FIG. 3.

FIG. 5 shows another flowchart depicting another method for balancing prediction signals.

FIG. 6 shows an electronic gaming table in accordance with another embodiment.

### DETAILED DESCRIPTION

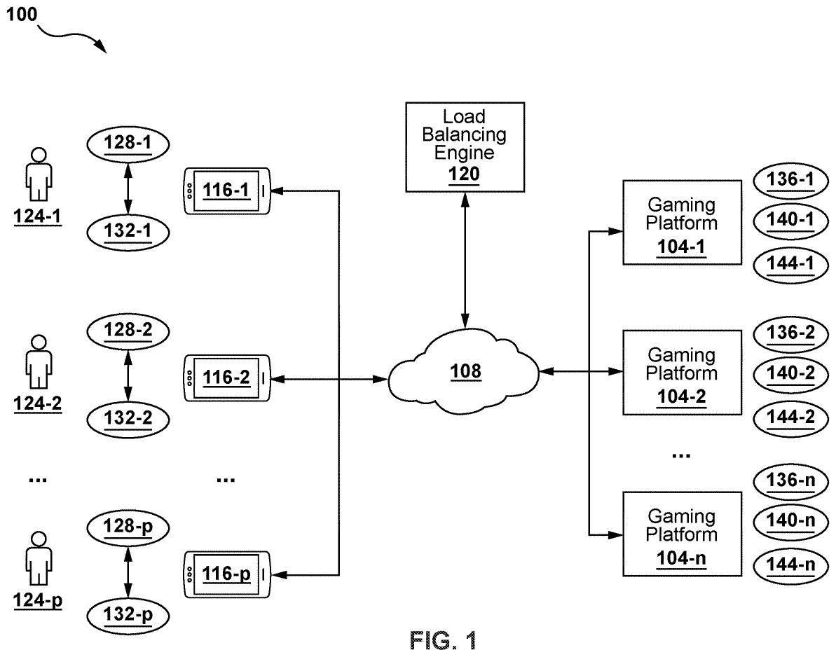

FIG. 1 shows a system for balancing prediction signals indicated generally at 100. System 100 comprises a plurality of platforms 104-1, 104-2 . . . 104-n. (Collectively, platforms 104-1, 104-2 . . . 104-n are referred to as platforms 104, and generically, as platform 104. This nomenclature is used elsewhere herein.) In system 100, platforms 104 connect to a network 108 such as the Internet. Network 108 interconnects gaming platforms 104 with a plurality of terminals 116 and a load balancing engine 120. As will be discussed further below, load balancing engine 120 performs a number of processing functions for system 100.

Platforms 104 can be based on any present or future interactive application servers. In a non-limiting example, platforms 104 can be gaming servers for online gaming interactions amongst users 124 operating terminals 116. Terminals 116 can be any type of human-machine interface for interacting with platforms 104. For example, terminals 116 can include traditional laptop computers, desktop computers, mobile phones, tablet computers and any other device that can be used to send and receive communications over network 108 and its various nodes that complement the input and output hardware devices associated with a given terminal 116. It is contemplated terminals 116 can include virtual or augmented reality gear complementary to virtual reality or augmented reality or “metaverse” environments that can be offered on gaming platforms 104. Terminals 116 can be operated by different users 124 that are associated with a respective identifier object 128 that uniquely identifies a given user 124 accessing a given terminal 116 in system 100. A value storage unit in the form of a currency account 132 is also associated with each identifier object 128.

In a present example embodiment, gaming platforms 104 can be based on media platforms or central servers that function to provide gaming interactions between different users 124 having an account associated with their identifier object 128 on those platforms 104. Gaming interactions are not particularly limited but can include any form of game that includes a plurality of users 124 which combines skill and chance and includes rounds of predictions (“betting”) made by users 124 as to an outcome of the game. Each prediction is accompanied by an amount represented by a currency transferred from currency account 132 associated with the identifier object 128. As part of the game, predictions may be optional, however, continued participation in the game may depend on the provision of a prediction and a minimum amount of currency. The nature of the currency can vary depending on local laws and regulations governing the operation of the system 100, such as currencies representing in-game value or others that are equivalent to hard currency; it does not affect the present specification one way or the other.

During the game, currency from each round of predictions is pooled into a collective account 136 (e.g. in online poker, the “pot”; this may be referred to by other colloquialisms depending on the game) respective to the gaming platform 104 hosting the relevant game. Once an outcome corresponding to the predictions becomes known, typically at the end of a game, a user 124 that made accurate predictions is awarded a portion of the collective account 136, which is transferred to the currency account 132 associated with that user 124. (e.g. in online poker, the “winnings”; this may be referred to by other colloquialisms depending on the game). The remainder of the collective account 136 is transferred to the gaming platform currency account 140 (e.g. in online poker, the “pot rake”; this may be referred to by other colloquialisms depending on the game). A further portion of the collective account 136 is allocated to a loyalty account 144 (e.g. in online poker “rake back”; this may be referred to any other colloquialisms depending on the game).

Portions of the currency within loyalty account 144 are then distributed amongst the accounts 132 of users 124 that made inaccurate predictions according to an algorithm implemented by load balancing engine 120. The algorithm configures load balancing engine 120 to control gaming platforms 104 to maximize the utilization of the computing resources of each platform 104. One portion of the algorithm, in an embodiment, can be based on the number of times a user 124 made a prediction, even if those predictions were incorrect. The algorithms, numbers of predictions, collective account 136 values, platform account 140 values, and loyalty account 144 values, and related threshold levels are constantly monitored by load balancing engine 120, making adjustments to seek to maximize utilization of computing resources of platforms 104 within system 100.

A present illustrative example of a gaming platform 104 is online poker, but any online game according to the foregoing general structure is contemplated. In the context of online poker, the collective account 136 maybe colloquially referred to as the “pot”; the portion of the collective account 136, which is transferred to the currency account 132 associated with a user 124 that made the accurate predictions by winning the hand of poker may be colloquially referred to as “winnings”; while the distribution from the loyalty account 144 may be referred to as the “rake back”. The platform currency account 140 may be colloquially referred to as the “pot rake”; The nature of gaming platforms 104 is thus not particularly limited. Very generally, platforms 104 provide a means for users 124 to play online games with each other via terminals 116, while load balancing engine 120 makes adjustments to maximize utilization of platforms 104. Thus, in variants, the present specification may be applied to a multiplayer game such as a modified version of a “Battle Royale” mode in a game, such as Fortnite, where during predefined moments players are encouraged to make a prediction as to the likelihood that they, or their team, will be victorious.

At this point it is to be clarified and understood that the nodes in system 100 are massively scalable, to accommodate a large number of users 124, terminals 116, and gaming platforms 104. Accordingly, terminals 116 are based on any suitable client computing platforms (with examples noted above) operated by users 124 that may have an interest in participating in a game with other users 124 on one or more gaming platforms 104. Each terminal 116 and its user 124 is thus associated with a user identifier object 128 and an electronic currency account 132.

A person of skill in the art is to recognize that the form of an identifier object 128 is not particularly limited, and in a simple example embodiment, can be an alpha-numerical sequence that is entirely unique in relation to other identifier objects in system 100. Identifier objects can also be more complex as they may be combinations of account credentials (e.g. user name, password, Two-factor authentication token, etc.) that uniquely identify a given user 124. Identifier objects themselves may also be indexes that point to other identifier objects, such as accounts. The salient point is that they are uniquely identifiable within system 100 in association with what they represent, and can be associated with accounts for each user 124 on one or more platforms 104.

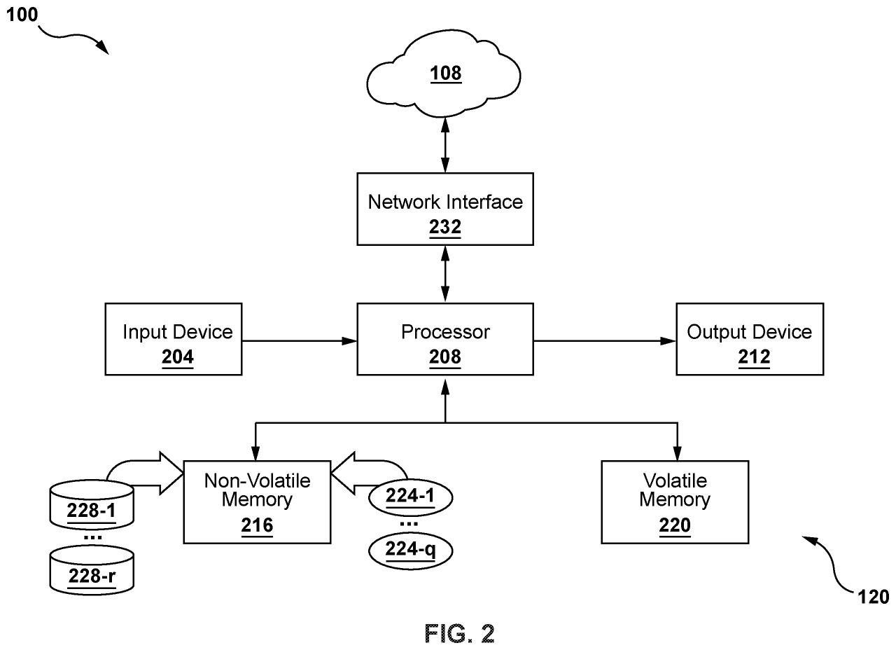

Having described an overview of system 100, it is useful to comment on the hardware infrastructure of system 100. FIG. 2 shows a schematic diagram of a non-limiting example of internal components of load balancing engine 120.

In this example, load balancing engine 120 includes at least one input device 204. Input from device 204 is received at a processor 208 which in turn controls an output device 212. Input device 204 can be a traditional keyboard and/or mouse to provide physical input. Likewise output device 212 can be a display. In variants, additional and/or other input devices 204 or output devices 212 are contemplated or may be omitted altogether as the context requires.

Processor 208 may be implemented as a plurality of processors or one or more multi-core processors. The processor 208 may be configured to execute different programing instructions responsive to the input received via the one or more input devices 204 and to control one or more output devices 212 to generate output on those devices.

To fulfill its programming functions, the processor 208 is configured to communicate with one or more memory units, including non-volatile memory 216 and volatile memory 220. Non-volatile memory 216 can be based on any persistent memory technology, such as an Erasable Electronic Programmable Read Only Memory (“EEPROM”), flash memory, solid-state hard disk (SSD), other type of hard-disk, or combinations of them. Non-volatile memory 216 may also be described as a non-transitory computer readable media. Also, more than one type of non-volatile memory 216 may be provided.

Volatile memory 220 is based on any random access memory (RAM) technology. For example, volatile memory 220 can be based on a Double Data Rate (DDR) Synchronous Dynamic Random-Access Memory (SDRAM). Other types of volatile memory 220 are contemplated.

Processor 208 also connects to network 108 via a network interface 232. Network interface 232 can also be used to connect another computing device that has an input and output device, thereby obviating the need for input device 204 and/or output device 212 altogether.

Programming instructions in the form of applications 224 are typically maintained, persistently, in non-volatile memory 216 and used by the processor 208 which reads from and writes to volatile memory 220 during the execution of applications 224. Various methods discussed herein can be coded as one or more applications 224. One or more tables or databases 228 are maintained in non-volatile memory 216 for use by applications 224.

The infrastructure of load balancing engine 120, or a variant thereon, can be used to implement any of the computing nodes in system 100, including platforms 104 and booking engines 112. Furthermore, load balancing engine 120, platforms 104 and booking engines 112 may also be implemented as virtual machines and/or with mirror images. Load balancing engine 120 may also be incorporated directly into platforms 104, thereby obviating the need for a central load balancing engine 120. By the same token, a plurality of load balancing engines 120 may be provided, especially when system 100 is scaled.

Furthermore, a person of skill in the art will recognize that the core elements of processor 208, input device 204, output device 212, non-volatile memory 216, volatile memory 220 and network interface 232, as described in relation to the server environment of load balancing engine 120, have analogues in the different form factors of client machines such as those that can be used to implement terminals 116. Again, terminals 116 can be based on computer workstations, laptop computers, tablet computers, mobile telephony devices or the like.

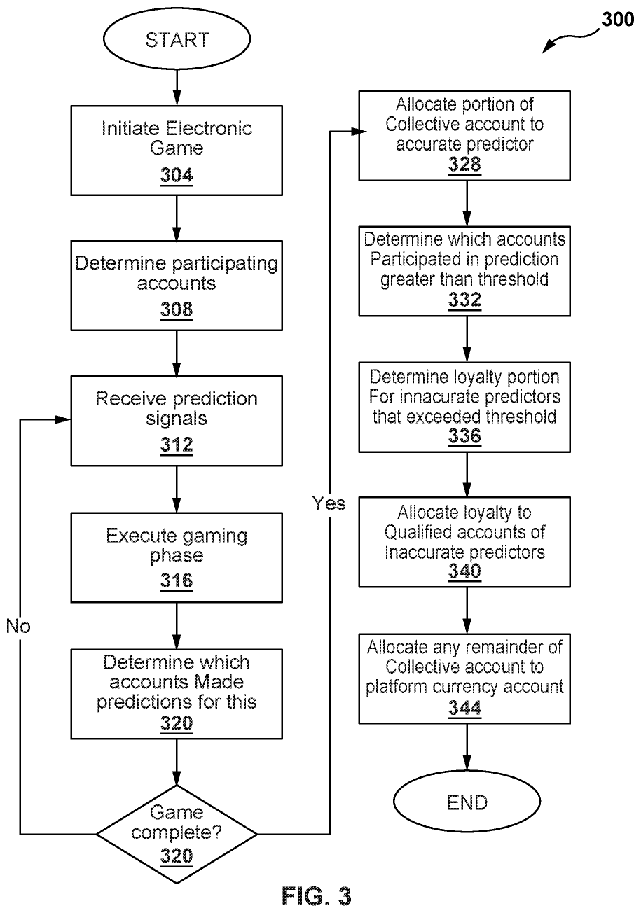

FIG. 3 shows a flowchart depicting a method for resource load balancing indicated generally at 300. Method 300 can be implemented on system 100. Persons skilled in the art may choose to implement method 300 on system 100 or variants thereon, or with certain blocks omitted, performed in parallel or in a different order than shown. Method 300 can thus also be varied. However, for purposes of explanation, method 300 will be described in relation to its performance on system 100 with a specific focus on treating method 300 as executing on one or more platforms 104, but method 300 is also monitored by load balancing engine 120.

Block 304 comprises initiating an electronic game. As noted above, the nature of the game is not particularly limited, but for a present illustrative example, online poker will be discussed. According to the specific illustrative example in system 100, it will be assumed that gaming platform 104-1 has an online poker game initiated. (For now, for simplifying the explanation, the status of the remaining gaming platforms 104 other than gaming platform 104-1 are ignored, but it will become appreciated how they can also be initiated and form part of the present teachings.) Any online poker format can be employed, such as Texas Hold'Em, Omaha 4, Omaha 5 and Omaha 6.

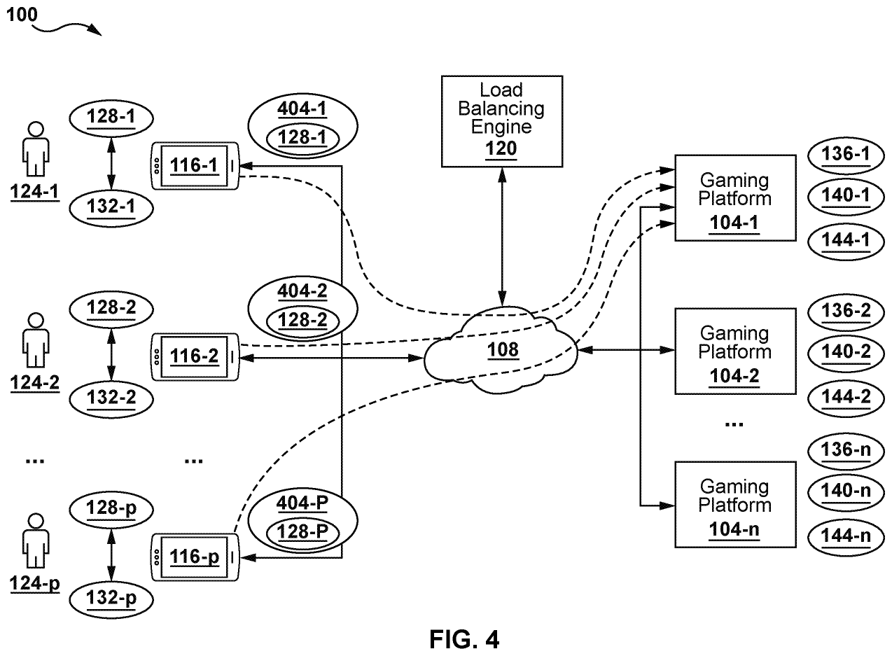

Block 308 comprises determining the participating accounts. To elaborate according to our example, at block 308, platform 104-1 receives electronic signals from a plurality of terminals 116, including associated identifier objects 128, which indicate which users 124 are will “play” or otherwise participate in the electronic game initiated at block 304. FIG. 4 shows an illustration whereby all users 124 shown in FIG. 1 send signals 404 via their terminals 116 to gaming platform 104-1 that include their account identifier objects 128, indicating their participation in the game initiated at block 304.

Block 312 comprises receiving prediction signals. According to our specific example, each user 124 will control their terminal 116 to allocate a certain amount of currency in their account 132 and transfer that amount, electronically, to the collective account 136-1 of platform 104-1. The amount of currency can be predetermined by the rules of the game as enforced by platform 104-1, such as “ante” or a “blind”, whereby the user 124 is making a prediction that they will be the successful player.

Block 316 comprises executing gaming phase. In general terms, block 316 contemplates the exchange of signals between platforms 104 and terminals 116 that implement the electronic interactions that represent the actual play of the game. In the example of online poker, block 316 includes platform 104-1 dealing a virtual hand of poker, according to the specific poker game being employed. For example, if the online poker game is Texas Hold'Em, then upon initial performance of block 316, each terminal 116 per its associated account to a respective object 128 receives electronic representations of two private “hole” cards. (During subsequent cycles of method 300, in the case of the Texas Hold'em example, these stages are colloquially referred to as the “flop”, “turn” and “river” stages.) Block 320 comprises determining which accounts had associated predictions. According to this example, records are kept as to which associated accounts to respective objects 128 participated in sending prediction signals at block 312. As will become apparent from further discussion, the certain accounts that participated at block 308, but do not participate in the prediction at block 312, can result in overall underutilization of platform 104-1, since the connection between a given client terminal 116 and the platform 104-1 is active as per block 308, but signals are not being transferred over that connection at block 312. Accordingly, processing and memory resources on platform 104-1 can be wasted.

Block 324 comprises determining if the game initiated at block 304 is complete. In the Texas Hold'Em example a “no” determination is made until the “flop”, “turn” and “river” stages are complete, leading the method back to block 312 where additional prediction signals are received and the method continues as previously described, noting at block 320 which accounts made predictions at block 312.

A “yes” determination is made at block 324 when the particular game is complete. In the Texas Hold'Em example, this may referred to as the completion of a “round” or “hand” or “deal”.

Block 328 comprises allocating a predefined portion of the collective account to the currency account associated the identifier object that made the most accurate prediction(s) at block 312. In our example of platform 104-1, assume that user 124-1 at terminal 116-1 made the most accurate prediction(s) by “winning” the game of Texas Hold'Em, in which case a portion of the currency accumulated in collective account 136-1 (the “winnings”) is transferred to currency account 132-1. As will be discussed further below, the predefined portion can be variable according to the load balancing aspects of system 100.

Block 332 comprises determining which accounts that participated at block 308 made predictions, as counted at block 320, greater than a predefined threshold. The predefined threshold can be based on a number of times as counted at block 320. As will be discussed further below, the predefined threshold can be variable according to the load balancing aspects of system 100.

Block 336 comprises determining a loyalty portion for inaccurate predictors that exceeded the threshold at block 332. To elaborate, a remaining portion of the collective account 136-1 is transferred to the loyalty account 144, and then portions of loyalty account 144 are notionally allocated amongst the identifier objects 128 associated with the users 124 that made inaccurate predictions and which exceeded the threshold from block 332. Block 340 comprises transferring the allocations from block 336 to currency accounts 132 respective to those users 124 that made inaccurate predictions.

At this point it can be seen that, in method 300, loyalty account 144 allocations are higher for those participants from block 308 that also generate a certain number of prediction signals at block 312, regardless of the accuracy of those predictions.

Block 344 comprises allocating any remainder of the collective account to the platform currency account. In the specific example discussed above, this means that the portion of collective account 136-1 that was not placed into loyalty account 144-1 is transferred to the platform currency account 140-1. It should be understood that while several variations to method 300 are contemplated, in particular it can be noted that block 344 can be omitted altogether in that the entirety of currency in account 136-1 can be allocated at block 328 or at block 340.

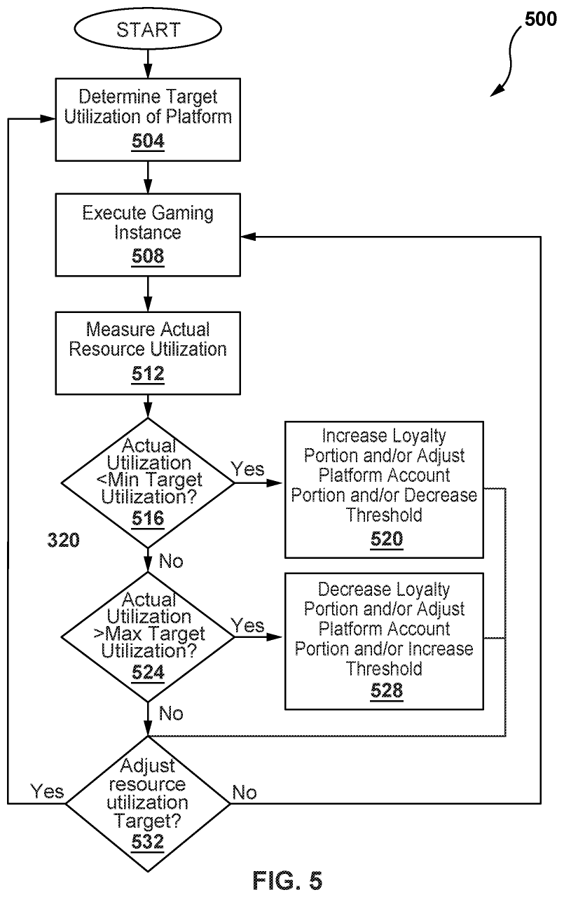

FIG. 5 shows a flowchart depicting a method for resource load balancing indicated generally at 500. Method 500 can be implemented on system 100. Persons skilled in the art may choose to implement method 500 on system 100 or variants thereon, or with certain blocks omitted, performed in parallel or in a different order than shown. Method 500 can thus also be varied. However, for purposes of explanation, method 500 will be described in relation to its performance on system 100 with a specific focus on treating method 300 as, for example, application 224-1 maintained within load balancing engine 120 and its interactions with the other nodes in system 100.

When considering method 500 in relation to system 100, load balancing engine 120 performs a supervisory function over the remaining nodes in system 100 to adjust various thresholds and currency allocations to maximize central processing unit (CPU) or processor usage, memory consumption and other performance metrics of the hardware used to implement platform 104. Engine 120, which has access to monitoring tools in each of the platforms that can report back to engine 120 the amount of computing resources being consumed by a given platform.

Thus, block 504 comprises determining a target utilization of platform resources. Block 504 is performed at engine 120, and sets desired target utilizations of platforms 104. For example, engine 120 may set a target range of between about 20% and about 80% of CPU usage for each platform 104. Engine 120 may set a target range of between about 30% and about 70% of CPU usage for each platform 104. Engine 120 may set a target range of between about 40% and about 60% of CPU usage for each platform 104. Engine 120 may set a target range of between about 45% and about 55% of CPU usage for each platform 104. Engine 120 may set a target range of about 50% of CPU usage for each platform 104.

Engine 120 may set a target range of between about 25% and about 75% of memory usage for each platform 104. Engine 120 may set a target range of between about 35% and about 75% of memory usage for each platform 104. Engine 120 may set a target range of between about 40% and about 60% of memory usage for each platform 104. Engine 120 may set a target range of between about 45% and about 55% of memory usage for each platform 104. Engine 120 may set a target range of about 50% of bandwidth usage for each platform 104.

Engine 120 may set a target ranges for bandwidth consumption over network 108, of between about 25% and about 75% of bandwidth usage for each platform 104. Engine 120 may set a target range of between about 35% and about 75% of bandwidth usage for each platform 104. Engine 120 may set a target range of between about 40% and about 60% of bandwidth usage for each platform 104. Engine 120 may set a target range of between about 45% and about 55% of bandwidth usage for each platform 104. Engine 120 may set a target range of about 50% of bandwidth usage for each platform 104.

Block 508 comprises executing a gaming instance. Method 400 is an example of a gaming instance that can be used to implement block 508, with the performance of method 400 being monitored by engine 120. However, as noted, method 400 is one embodiment and other gaming instances that vary on method 400 can also be implemented at block 508. To reemphasize, online poker is but one embodiment and other online games are also contemplated. For purposes of an example explanation of method 500, however, reference will be made to method 400 and previous aforementioned example of Texas Hold'Em.

Block 512 comprises measuring actual resource utilization. Thus engine 120 will utilize resource monitoring tools maintained within each platform 104 to assess processor, memory, bandwidth usage. It is to be reemphasized that other computing resource measurements at block 504 and block 512 are contemplated. Generally, the resource utilization measured at block 512 will be based on the the metrics that established the target resource utilization from block 504.

Block 516 comprises determining whether the actual utilization of the resources as measured at block 512 is less than a minimum target utilization defined at block 504. Thus, for example, if CPU usage is below a certain target threshold level (such as those ranges and/or values indicated above), then a “yes” determination is made and block 520 is invoked.

Block 520 comprises adjusting aspects of thresholds associated with the gaming instance invoked at block 508. Continuing with the example of method 400 and platform 104-1, block 520 can comprise increasing the loyalty portion determined at block 336 and/or increasing the platform account portion at block 344 and/or decreasing the threshold number of predictions at block 332. In this manner, during performance of block 328, block 332, block 336 and block 340, additional loyalty signals may be returned to terminals 116-1 thereby increasing overall computing resource and bandwidth utilization by platform 104-1. Additionally, in the event that one of the users 124 demonstrates a high level of repeated ability to make accurate predictions, block 520 helps mitigate the effects of the remaining users 124 becoming aware of such a pattern and thereby declining to participate in providing their own prediction signals. In other words, if a given player shows a dominant level of skill over the other players, system 100 adjusts its behaviour by increasing the loyalty reward to the other players, thereby maintaining, on average, higher levels across all currency accounts 132 and encouraging all users 124 to participate more equally on the gaming platform 104, thereby providing an opportunity to keep gaming platforms 104 operating within a desired level of computing resource utilization as defined at block 508.

When implemented in online poker algorithms for block 520 can be based on the colloquial “Voluntary Put Money in Pot” (“VPIP”) tracks the percentage of hands in which a particular player voluntarily puts money into the pot (i.e. generates a prediction signal at block 312) at “preflop”. VPIP increases when a player could fold but instead commits money to the “pot”, “preflop”. This includes limping (merely calling the big blind), calling, and raising.

VPIP, or “Voluntarily Put Money in Pot,” is a poker statistic used to measure a player's overall aggressiveness and is typically used in the context of online poker. VPIP is expressed as a percentage and represents the frequency with which a player puts money into the pot preflop, whether by calling, raising, or completing the blinds.

The VPIP percentage is calculated by dividing the number of times a player voluntarily puts money in the pot by the total number of hands played. A higher VPIP percentage indicates a looser, more aggressive playing style, while a lower VPIP percentage signifies a tighter, more passive approach.

For example, a player with a VPIP of 10% would voluntarily contribute to the pot in only 10% of the hands they play, indicating a very tight and selective playing style. On the other hand, a player with a VPIP of 40% would contribute to the pot in 40% of the hands they play, suggesting a much looser and aggressive style.

VPIP is often used in combination with other poker statistics, such as PFR (Preflop Raise percentage) and AF (Aggression Factor), to help players analyze their opponents' playing styles and make better decisions at the table.

These aspects of online poker can be used to make adjustments at block 520 in order to coax system 100 towards the target resource utilization.

Returning to block 516, if, on the other hand, that the actual utilization from block 512 is greater than a minimum target utilization, then a “no” determination is made at block 516 and method 500 proceeds to block 524. Block 524 comprises determining if the actual utilization from block 512 exceeds a maximum target utilization as defined at block 504.

A “yes” determination at block 524 leads to block 528, which effects an opposite set of adjustments to block 520, which “cools off” excessive predictions that may over-tax the computing resources of platform 104. Block 528, which is an inverse to block 520. In other words, the amount of the loyalty portion can be decreased, and/or the amount of the platform account and/or the threshold of number of predictions at block 332 can be increased, to thereby “cool off” the number of prediction signals sent at block 312 and thereby decrease overall computing resource utilization of platform 104.

A “no” determination at block 524 leads to block 532, which means that the actual utilization of resources at block 512 is within the target range at block 504. Block 532 is also reached from block 520 and block 528. Thus block 532 comprises determining if the target resource utilization itself should be adjusted. A “yes” determination leads back to block 504, whereas a “no” determination leads back to block 508 and the process repeats.

Block 532 may reach a “yes” determination where, for example, lower target utilization thresholds are consistently not met by method 500 regardless of adjustments made at block 520. In this event, engine 120 can also merge different gaming platforms 104 into a single gaming platform 104. The opposite is also true, where upper target utilization thresholds are consistently exceeded and yet adjustments at block 528 do not sufficiently “cool off” the signals between terminals 116 and the relevant platform 104. In this event, engine 120 can automatically spawn additional instances of platforms 104. In this context, when platforms 104 are implemented as virtual machines, the number and processing resources of those virtual machines can be dynamically increased and decreased, in conjunction with method 500, to perform overall load balancing of system 100.

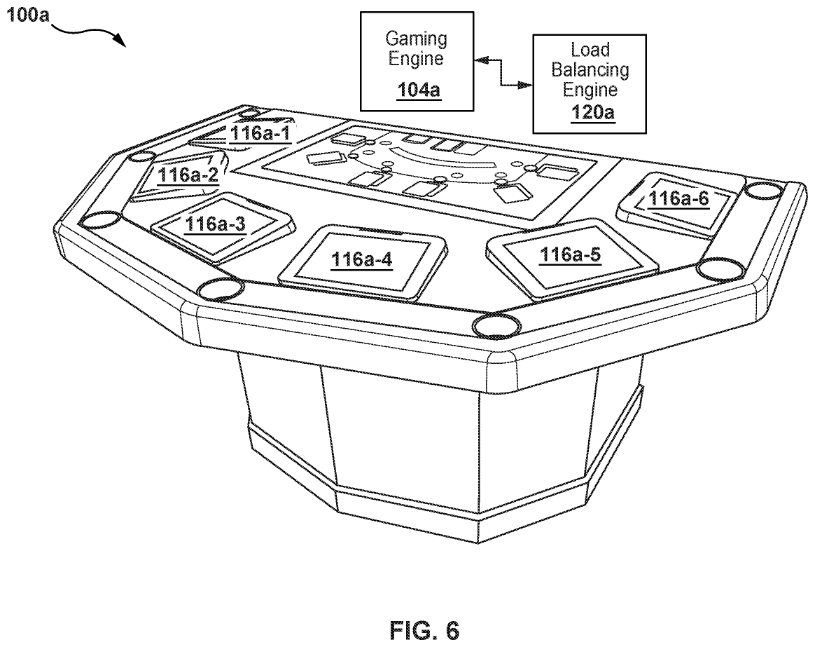

Referring now to FIG. 6, an electronic gaming table in accordance with another embodiment is indicated generally at 100a. Table 100a is a implements system 100 as a Video Poker Machine or Electronic Poker Table. Table 100a includes like elements to system 100, except followed by the suffix “a”. Table 100a thus includes a plurality of player terminals 116a which are analogous to terminal 116. Table 100a also includes a gaming engine 104a which performs the dealer functions of the table 100a, like platform 104, and a load balancing engine 120a which controls engine 104a in order to bring utilization of the gaming engine 104a by incentivizing the increase of prediction signals from different player terminals 116a.

In view of the above it will now be apparent that variations, combinations, and subsets of the foregoing embodiments are contemplated.

For example, in a variant, platforms 104 can be virtual machines hosted by cloud services platforms such as Amazon Web Services (“AWS”) or Google Cloud, or Microsoft Azure, which can be dynamically scaled up and down by load balancing engine 120, with load balancing engine 120 configured to achieve a desired level of computing resource utilization, dynamically increasing or decreasing the virtual machine capacity of each platform 104 as load balancing engine 120 influences increases or decreases in the number of participating terminals 116 and associated numbers of predictions, using the teachings herein.

A person skilled in the art will now appreciate that the teachings herein can improve the technological efficiency and computational and communication resource utilization across system 100. Platforms 104 that do not have the benefit of load balancing engine 120 may be chronically underutilized, especially when one particular user 124 has a pattern of making accurate predictions more often than others.

It should be recognized that features and aspects of the various examples provided above can be combined into further examples that also fall within the scope of the present disclosure. In addition, the figures are not to scale and may have size and shape exaggerated for illustrative purposes.

1. An interactive platform including a processor and a memory, the processor configured to:
define a target resource utilization range of one or more of processor, memory and or bandwidth utilization of the platform;
initiate an interactive application on the platform;
determine a plurality of participating accounts associated with electronic devices that connect to the platform via a network;
receive prediction signals for an outcome of the application from the at least a portion of the participating accounts;
execute a phase of the application;
determine which participating accounts generated prediction signals;
allocate a first portion of a collective account to a value storage unit associated with one of the participating accounts associated with an accurate prediction;
allocate a second portion of the collective account amongst one or more value storage unit associated with the other participating accounts based on a number of prediction signals received from the other participating accounts;
wherein the second portion is adjusted to bring the overall number of signals within the target resource utilization range utilization during subsequent phases.

2. A system comprising a plurality of platforms hosting the interactive application according to claim 1; the target utilization range including one or more of processor, memory and bandwidth utilization of each platform;
the target utilization range including a substantial balancing of processor, memory and bandwidth utilization across each platform.

3. The interactive platform of claim 1 wherein the target range is between about 20% and about 80% of processor utilization.

4. The interactive platform of claim 1 wherein the target range is between about 30% and about 70% of processor utilization.

5. The interactive platform of claim 1 wherein the target range is between about 40% and about 60% of processor utilization.

6. The interactive platform of claim 1 wherein the target range is between about 45% and about 55% of processor utilization.

7. The interactive platform of claim 1 wherein the target range is about 50% of processor utilization.

8. The interactive platform of claim 1 wherein the target range is between about 25% and about 75% of memory usage.

9. The interactive platform of claim 1 wherein the target range is between about 35% and about 75% of memory usage.

10. The interactive platform of claim 1 wherein the target range is between about 40% and about 60% of memory usage.

11. The interactive platform of claim 1 wherein the target range is between about 45% and about 55% of memory usage.

12. The interactive platform of claim 1 wherein the target range is between about 25% and about 75% of bandwidth usage of the network connection to the platform.

13. The interactive platform of claim 1 wherein the target range is between about 35% and about 75% of bandwidth usage of the network connection to the platform.

14. The interactive platform of claim 1 wherein the target range is between about 40% and about 60% of bandwidth usage of the network connection to the platform.

15. The interactive platform of claim 1 wherein the target range is between about 45% and about 55% of bandwidth usage of the network connection to the platform.

16. The interactive platform of claim 1 wherein the target range is between about 50% of bandwidth usage of the network connection to the platform.
